(19) United States
(12) Patent Application Publication
(10) Pub. No.: US 2002/0032275 A1
(43) Pub. Date: Mar. 14, 2002

(54) Hot melt coating composition

(76) Inventors: Michele Falcone, Newcastle Upon Tyne (GB); Faridoon Qazi, Malmo (SE); Kent Raabjerg Sorensen, Perstorp (SE); Martinus Adrianus Anthonius Maria Koenraadt, Duiven (NL)

Correspondence Address: David H. Vickrey, Akzo Nobel Inc., 7 Livingstone Avenue, Dobbs Ferry, NY, 10522-3408, US

(21) Appl. No.: 09/875,490

(22) Filed: Jun. 6, 2001

(30) Foreign Application Priority Data
Jun. 6, 2000 (EP) 00201990.9

(51) Int. Cl. C08J 3/00; C08K 3/00; C08L 75/00

(52) U.S. Cl. 524/589

(57) ABSTRACT

Thermosetting hot melt coating composition with a binder comprising:

a. 40-95%, preferably 50-90%, by total resin weight of at least one amorphous resin;

b. 5-60%, preferably 10-50%, by total resin weight of at least one semi-crystalline resin, e.g. a polyester, and/or one or more crystalline resins, such as urethane polyols or amide polyols.

Internally blocked isocyanates are preferred cross-linkers. The composition comprises at least one non-polymeric crosslink enhancer having two or more functional groups capable of reacting with the functional groups of the crosslinker and/or one or more of the used resins. Pigments may be dispersed in at least one of the semi-crystalline and/or crystalline resins, before the amorphous resin is blended with the semi-crystalline and/or crystalline resins.

The present application claims priority of European Patent Application No. 00201990.9, filed on Jun. 6, 2000.

### BACKGROUND OF THE INVENTION

The present invention relates to a thermosetting hot melt coating composition. Such hot melt coating compositions are known, for instance from WO 95/21706. The coating compositions of this publication are based on amorphous polyester resins and a crosslinker having blocked isocyanate groups. The coating composition is heated to 100-120° C. in a compounding unit and then, in a viscous form, applied to a band-shaped substrate. Subsequently, the temperature is raised to the curing temperature. After curing, the coated substrate is cooled. The coating compositions of this publication are based on standard powder coating raw materials. Such compositions generally have a very high melt viscosity at the application temperature, which causes poor flow characteristics and poor film appearance after curing. Increasing the melt viscosity by raising the application temperature results in premature crosslinking. Also, the high level of mechanical properties needed in the coil industry cannot be met by these compositions.

U.S. Pat. No. 4,990,364 discloses a solvent-free hot melt coating composition containing ethylenically unsaturated groups which can be cured by free radical hardening, UV or electron beam irradiation. Compositions based on these types of binders have moderate adhesion to the substrate, resulting in poor mechanical properties. Also, the outdoor durability of the resulting film is insufficient to pass the requirements of the coil industry.

EP-A 0 539 941 discloses a hot melt coating composition comprising two resins, the first one having a Tg above 20° C., the second one having a Tg below 20° C.

The object of the invention is to provide a hot melt coating composition which can be applied at relatively low temperature and which shows good flow properties and no premature crosslinking at the application temperature. The coating composition must give a good film appearance and outdoor durability and excellent mechanical properties after curing.

### SUMMARY OF THE INVENTION

The object of the invention is achieved by a hot melt coating composition with a binder comprising:

a. 40-95%, preferably 50-90%, by total resin weight of at least one amorphous resin;

b. 5-60%, preferably 10-50%, by total resin weight of at least one other resin selected from the group consisting of semi-crystalline resins, crystalline resins and mixtures thereof.

### DETAILED DESCRIPTION OF THE INVENTION

The phase changes establishing whether a resin is crystalline, semi-crystalline, or amorphous can be detected by Differential Scanning Calorimetry (DSC), as described in Encyclopedia of Polymer Science and Engineering, Volume 4, pages 482-519, 1986 (Wiley lnterscience). A resin is considered to be amorphous if it shows a discernible glass transition temperature (Tg) and neither crystallisation nor melting peaks. A resin is considered to be semi-crystalline resin if it shows a discernible Tg and at least one melting peak. In general, when different melting peaks are observed in a DSC curve, these multiple peaks are specified by a melting range. If a resin does not show any Tg on heating from −60° C., but only a sharp melting peak, it is considered to be crystalline.

It has been found that contents of (semi-)crystalline resins below the above-defined range do not show the desired effects, whereas contents above the above-defined range result in a low Tg of the cured film, which is made manifest by low solvent resistance and soft films.

The amorphous resin may for example be a polyester resin, a polyacrylate, an epoxy resin, a polyurethane, a phenoxy resin, or hybrids or mixtures thereof. Polyester resins are preferred. The amorphous resin generally has a Tg between 0° C. and 80° C. Preferably, the amorphous resin has a Tg higher than 30° C. The melt viscosity of the amorphous resin generally is between 500 Pa.s and 3,000 Pa.s, measured at 150° C. at a shear rate of 30 s⁻¹.

Examples of suitable amorphous polyester resins are the reaction product of aromatic and/or (cyclo)aliphatic polycarboxylic acids with aromatic and/or (cyclo)aliphatic polyalcohols. Examples of aromatic, aliphatic, and cycloaliphatic polycarboxylic acids are isophthalic acid, terephthalic acid, adipic acid, sebacic acid, hexahydroterephthalic acid, maleic acid, and, if available, their anhydrides, acid chlorides or lower alkyl esters such as dimethyl terephthalate.

Useful polyalcohols, in particular diols, are for example ethylene glycol, 1,2-propanediol, 1,3-propanediol, 1,2 butanediol, 1,3-butanediol, 1,4-butanediol, neopentyl glycol, 1,6-hexanediol, 1,4-dimethylol cyclohexane, hydrogenated Bisphenol A, diethylene glycol, etc. Small amounts of polyfunctional polycarboxylic acids or polyalcohols may be used in order to obtain branched polyester resins. Examples of such compounds are glycerol, trimethylol ethane, trimethylol propane, and trimellitic anhydride.

Also polyester resins with a highly branched structure called hyperbranched or dendritic polymers can be used. Such products are commercially available for example under the trademark Boltorn® supplied by Perstorp Specialty Chemicals.

The semi-crystalline and/or crystalline resins may for example be a polyester resin, a polyacrylate, a polyamide, a polyurethane, or hybrids or mixtures thereof. For the semi-crystalline resins, polyester resins are preferred. The semi-crystalline resin typically has a Tg below 50° C., generally between −20° C. and 50° C., preferably from −15° C. to about 40° C. Both the semi-crystalline and the crystalline resins typically have melting temperatures between 40 and 150° C., and melt viscosities ranging from 0.005 Pa.s to 10 Pa.s, measured at 150° C. at a shear rate of 30 s⁻¹.

Preferably, the semi-crystalline and crystalline resins are linear. However, branched resins can also be used. Also mixtures of linear and branched semi-crystalline and/or crystalline resins can be used. Branched resins have the advantage that the crosslink density of the cured film can be increased without disadvantageously affecting the melt viscosity of the uncured coating composition. This is especially useful when crosslinkers having an average functionality lower or equal to 2 are used. In order to obtain maximum crystallinity, the branching level should be kept to a minimum. Crystalline resins generally have a high level of crystallinity, resulting in fast crystallisation during the cooling down phase after synthesis of these compounds. In practice this means that almost immediately after the production of the crystalline resin the final product solidifies and can be mechanically handled and used as such.

Examples of suitable semi-crystalline polyester resins include the reaction product of aromatic and/or (cyclo)aliphatic polycarboxylic acids with aromatic and/or (cyclo)aliphatic polyalcohols. Examples of aromatic and (cyclo)aliphatic polycarboxylic acids are terephthalic acid, 1,4-hexahydroterephthalic acid, adipic acid, sebacic acid, succinic acid, and, if available, their anhydrides, acid chlorides or lower alkyl esters such as dimethyl terephthalate. Useful polyalcohols, in particular diols, are for example ethylene glycol, 1,3-propanediol, 1,4-butanediol, 1,6-hexanediol, 1,4-dimethylol cyclohexane, etc. Small amounts of polyfunctional polycarboxylic acids or polyalcohols may be used in order to obtain branched semi-crystalline polyester resins. Examples of such compounds are glycerol, trimethylol ethane, trimethylol propane, and trimellitic anhydride. Preferred monomers for use in the synthesis of the semi-crystalline polyester resins include those which contain an even number of carbon atoms. However, this does not preclude the use of monomeric polyacids or polyols containing an odd number of carbon atoms or the use of certain experimental techniques known to promote crystallinity in polymers, e.g., maintaining the polyester reaction product at a temperature mid-way between its Tg and the melting temperature for a period of time before cooling to ambient temperature.

The amorphous and semi-crystalline polyester resins can be prepared using conventional polymerisation procedures known to be effective for polyester synthesis. The reaction to form the polyester may be conducted in one or more stages. A catalyst such as dibutyl tin oxide can be used to accelerate the polycondensation reaction.

Examples of suitable crystalline resins with a high level of crystallinity are amide, urethane and ureum polyols. Urethane polyols can be prepared by different methods, for example by the addition of an isocyanate to a diol, as described in U.S. Pat. No. 5,155,201. Another suitable preparation method is the addition of cyclic carbonates to an amine. Suitable carbonates are for example ethylene carbonate and propylene carbonate. If glycerol carbonate is used, polyfunctional urethane polyols can be prepared. Useful amines are 1,6-hexamethylene diamine, 1,8-diaminooctane, 1,12-diaminododecane, 2,2-(ethylenedioxy)bis(ethylamine), and m-xylylene diamine. Amide polyols can also be prepared by different methods: for example by amidation of diacids or diesters with amino-alcohols or by ring opening reaction of amines with lactones. In the latter case diamines as described above and lactones such as epsilon-caprolacton, gamma-butyrolacton and beta-butyrolacton can be used. The preparation of amide polyols and urethane polyols produced by ring opening reaction of amines with lactones and cyclic carbonates, respectively, is generally performed at reaction temperatures between 120 and 140° C.

In this process the lactone or cyclic carbonate is first heated to the desired reaction temperature. When this temperature is reached, the amine is gradually dosed over such a time that the reaction can be controlled. The product is kept above the melting temperature of the final product until all the amine has reacted, which can be determined by titration.

The amorphous, semi-crystalline, and crystalline binders present in the hot melt coating composition in general are solid materials and free of any solvent and unreacted monomers.

Crosslinking should occur only above the softening/melting temperature of the uncured composition in order to prevent fouling of the compounder and associated equipment. Suitable crosslinkers are for instance polyisocyanates, polyfunctional epoxy resins, polycarboxylic acids, hydroxyalkylamides, polyoxazolines or amino resins, the amorphous and (semi-)crystalline resins having corresponding reactive functional groups. The functional groups can also be present in a compound having a hyperbranched or dendritic structure.

If the binders contain hydroxy-functional groups, blocked isocyanates are preferred crosslinkers. A suitable blocking agent is for example caprolactam. Most preferred are internally blocked isocyanates, particularly uretdiones. Alternatively or additionally, glycidyl-functional crosslinkers can be used if the binders comprise acid-functional groups. The amorphous/(semi-)crystalline binder combinations can also contain different functional groups which can be cured with one or more suitable crosslinkers with corresponding reactive functional groups.

In a preferred embodiment of the coating composition according to the present invention, the hot melt coating composition contains a non-polymeric, low-molecular weight compound having the functionality of increasing the crosslink density of the cured film. This compound called crosslink enhancer has at least two, but preferably more, functional groups capable of reacting with the functional groups of the crosslinker and/or one or more of the used resins. The amount of crosslink enhancer added to the coating formulation in general is between 0.1 and 5 weight %, preferably between 0.5 and 3 weight %, on total weight of binders and crosslinker. The crosslink enhancers which can be used generally are small molecules with a monomeric character. The molecular weight average weight generally is below 1000 g/mol, preferably between 100 and 500 g/mol. The compound can be liquid, solid or (semi)-crystalline. Also combinations of different crosslink enhancers with equal or different functionalities can be used, depending on the availability of functional groups in the main binder/crosslinker system.

Increased crosslink density of the cured film can also be obtained by increasing the functionality of the amorphous and/or (semi)-crystalline resins. However, increased crosslink functionality of the amorphous binder results in a significant increase in the melt viscosity, whereas if the functionality of the (semi)-crystalline resins is increased, the crystalline behaviour will be affected negatively. Crosslink enhancers such as described contribute to the crosslink density of the final system and also contribute to a low melt viscosity. Particularly when hot melt formulations are based on high levels of linear (semi)-crystalline resins and/or crosslinkers with an average functionality lower than or equal to 2, small amounts of crosslink enhancers will substantially improve the final film properties, like hardness and flexibility. To obtain a good balance of final properties, the Tg of the cured coating film in general is above 25° C.

Preferably, the crosslink enhancer comprises functional groups capable of reacting with the crosslinker. For example, if hydroxy-reactive functional crosslinkers such as blocked isocyanates are used, the crosslink enhancer comprises at least one polyol. Suitable examples in this particular case are trimethylol propane, di-trimethylol propane or hydroxy alkylamides.

Alternatively, the crosslink enhancer may comprise functional groups capable of reacting with functional groups present on the binders which are not reactive with the crosslinker. For instance, if hydroxy-functional polyester resins are used, the remaining acid-functional groups present in the polyester resin can be used to react with an epoxy-functional crosslink enhancer. Suitable crosslink enhancers of this type are for example triglycidyl isocyanurate and aromatic or aliphatic glycidyl esters.

The coating composition according to the invention preferably has a melt viscosity below 70 Pa.s at a temperature of 150° C. (measured with a Cone & Plate rheometer at frequency of 10 Hz).

The coating composition according to the invention may further comprise one or more pigments or fillers. Further, the coating composition may comprise additives of any desired type, for instance catalysts, flow agents, matting agents, etc.

The invention also includes a method of coating a substrate comprising the following steps:

a. blending the contents of a coating composition having a binder comprising 5-60%, preferably 1-50%, by total resin weight of at least one crystalline and/or semi-crystalline resin with 40-95%, preferably 50-90%, by total resin weight of at least one amorphous resin;

b. melting the composition by means of a compounder, e.g. an extruder, to the application temperature;

c. applying the coating composition on the substrate;

d. heating the applied coating composition to the curing temperature.

In the case of pigmented hot melt formulations, the pigments are preferably dispersed in the semi-crystalline and/or crystalline resin before the amorphous resin is blended with the crystalline and/or semi-crystalline resin. It has been found that dispersing pigments in this way allows hot melt paints with increased pigment concentration to be formulated without negatively affecting the mechanical properties of the final film. Depending on the pigment/binder ratio, the pigments can also be dispersed partly in the (semi-)crystalline resin and partly in the amorphous resin, preferably with the amount of pigments in the amorphous resin being kept to a minimum.

The hot melt coating compositions according the invention are preferably produced by first mixing all the raw materials in a mixing machine, preferably a high speed mixer. The obtained mixture is subsequently melt blended in a compounding unit, for example an extruder. Further handling of the resulting product depends on the Tg of the final product. If the Tg is above room temperature, the product will be solid and can be collected in the form of, e.g., chips, which can be reduced further into a fine powder if so desired. If the Tg of the final product is below room temperature, the melt-blended product can be collected for example in a drum, which can be used later in combination with application equipment like a drum melter to apply the hot melt coating composition to the substrate. Preferably, the hot melt coating composition has a Tg just above room temperature and is supplied in the form of flakes. In this case physical stability is ensured as well as easy handling of the hot melt coating composition.

The hot melt coating composition can be applied to the substrate by means of any melting unit which can heat the coating composition to above its softening and/or melting temperature. Depending on the physical state of the coating composition, suitable melting equipment can be selected, for example an extruder or a drum melter. The coating composition is fed to the melting unit and heated to the application temperature. In general, the maximum temperature is chosen such that no premature crosslink reaction can take place. The minimum temperature must be such as will ensure low melt viscosity, resulting in a good transfer from the melting unit to the substrate. Depending on the application, the layer thickness of the coating film in general is between 10 μm and 60 μm. In practice, the application temperatures will be between 100° C. and 150° C. After application, the hot melt coating composition is generally cured in an oven which can be a (near-) infrared oven, a gas oven or an oven of any other suitable type. If the coating is applied for example as a coil coating, the curing temperature generally is between 150° C. and 350° C. and preferably between 200° C. and 260° C. These temperatures are known as “peak metal temperatures,” which means that the temperature in the curing oven can be higher. Curing times in practice are very short and generally range between 15 and 120 seconds. Suitable substrates which can be coated with the hot melt coating formulations include cold-rolled steel, aluminium, and galvanised steel. However, other metal or non-metal substrates allowing the curing temperatures can also be used.

The invention is further illustrated by the following examples. In these examples the following test methods were used:

Test methods:

| | |
|---|---|
| Acid number | ISO 3682 |
| Hydroxyl number | DIN 53240 |
| Viscosity | ISO 53229 |
| Tg, melting range | DSC, 10° C./min |
| Gardner Impact resistance | ASTM D2794-93 |
| Pencil hardness | NEN 5350 |
| T-bend | ASTM D-4145 |

For the amorphous resins the viscosity was tested at 200° C. For the semi-crystalline resins of the examples, the viscosity was tested at 125° C.

In the examples the compounds listed below are present as indicated.

| | |
|---|---|
| Araldite ® | triglycidyl isocyanurate, commercially available from |
| PT810 | Ciba Specialty Chemicals; |
| Araldite ® | aromatic glycidyl ester, commercially available from |
| PT910 | Ciba Specialty Chemicals; |
| Araldite ® | aliphatic glycidyl ether, commercially available from |
| DY0396 | Ciba Specialty Chemicals; |
| Benzoin | degassing agent, commercially available from DSM; |
| Crelan ® | internally blocked polyisocyanate, commercially |
| VPLS 2147 | available from Bayer; |
| Crylcoat ® 164 | catalyst, commercially available from UCB Chemicals; |
| Kronos ® 2310 | titanium dioxide pigment, commercially available from |
| | Kronos International Inc.; |
| Primid ® XL-552 | hydroxyalkylamide, commercially available |
| | from EMS; |
| Resiflow ® PV88 | flow agent, commercially available from Worlee |
| Uralac ® P6401 | amorphous polyester resin, commercially available |
| | from DSM; |
| Vestagon ® | caprolactam blocked polyisocyanate, commercially |
| B 1530 | available from Creanova; |
| Vestagon ® | internally blocked polyisocyanate, commercially |
| BF 1540 | available from Creanova. |

In the examples, the following abbreviations are used for the compounds as indicated.

| | |
|---|---|
| DBTDL | dibutyl tin dilaurate |
| DDA | dodecanoic acid |
| Di-TMP | di-trimethylol propane, commercially available from |
| | Perstorp Specialty Chemicals |

In the examples, all amounts of contents are given in grams, unless indicated otherwise. As starting materials for the examples three amorphous polyester resins were prepared, as well as five semi-crystalline polyester resins.

### Preparation of Amorphous Polyester Resins A1, A2, and A3

Amorphous Polyester Resin A1

A 2-liter reaction vessel equipped with a stirrer, a thermometer, a distilling unit, and a nitrogen inlet was charged with 597.4 g (10.3 equivalents) of neopentyl glycol (90 wt % in water), 68.3 g of trimethylolpropane (1.5 equivalents), and 0.75 g of dibutyl tin oxide. With stirring and passing over nitrogen the temperature was raised to 80° C., until a clear solution was obtained. In addition 33 g of adipic acid (0.45 equivalent), 838.5 g of terephthalic acid (10.1 equivalents), and 22.5 g of isophthalic acid (0.27 equivalent) were added. The temperature was slowly raised to 240° C., with water being discharged. The reaction was continued until the polyester had an acid number lower than 6 mg KOH/g. The resin was cooled down and poured out.

The resin had the following properties:

| | |
|---|---|
| Acid number | 5.8 mg KOH/g |
| Hydroxyl number | 50 mg KOH/g |
| Viscosity (200° C.) | 5.5 Pa · s |
| Tg | 53° C. |

Amorphous Polyester Resin A2

A 2-liter reaction vessel equipped with a stirrer, a thermometer, a distilling unit, and a nitrogen inlet was charged with 534 g (9.2 equivalents) of neopentyl glycol (90 wt % in water), 68.1 g of trimethylol propane (1.5 equivalents), 55.5 g (0.94 equivalent) of 1,6-hexanediol, and 0.75 g of dibutyl tin oxide. With stirring and passing over nitrogen the temperature was slowly raised to 80° C., until a clear solution was obtained. In addition 48 g of adipic acid (0.66 equivalent), 828.4 g of terephthalic acid (10.0 equivalents), and 19.5 g of isophthalic acid (0.23 equivalent) were added.

The temperature was slowly raised to 240° C., with water being discharged. The reaction was continued until the polyester had an acid number lower than 8 mg KOH/g. The resin was cooled down and poured out.

The resin had the following properties:

| | |
|---|---|
| Acid number | 6.0 mg KOH/g |
| Hydroxyl number | 41 mg KOH/g |
| Viscosity (200° C.) | 6.0 Pa · s |
| Tg | 50° C. |

Amorphous Polyester Resin A3

A 2-liter reaction vessel equipped with a stirrer, a thermometer, a distilling unit, and a nitrogen inlet was charged with 563.3 g (9.7 equivalents) of neopentyl glycol (90 wt % in water), 102.4 g of trimethylolpropane (2.3 equivalents), and 0.75 g of dibutyl tin oxide. With stirring and passing over nitrogen the temperature was slowly raised to 80° C., until a clear solution was obtained. In addition 63.4 g of adipic acid (0.87 equivalent) and 827.2 g of isophthalic acid (10.0 equivalents) were added. The temperature was slowly raised to 240° C., with water being discharged. The reaction was continued until the polyester had an acid number lower than 6 mg KOH/g. The resin was cooled down and poured out.

The resin had the following properties:

| | |
|---|---|
| Acid number | 5.4 mg KOH/g |
| Hydroxyl number | 51 mg KOH/g |
| Tg | 49° C. |

### Preparation of Semi-Crystalline Polyester Resins C1-C5

Semi-Crystalline Polyester Resin C1

A 2-liter reaction vessel equipped with a stirrer, a thermometer, a distilling unit, and a nitrogen inlet was charged with 680.5 g (11.5 equivalents) of 1.6-hexanediol. With stirring and passing over nitrogen the temperature was slowly raised to 80° C., until a clear solution was obtained. In addition 516.3 g (6.2 equivalents) of terephthalic acid, 303.1 g (4.1 equivalents) of adipic acid, and 0.75 g of dibutyl tin oxide were added. The temperature was slowly raised to 240° C., with water being discharged. The reaction was continued until the polyester had an acid number lower than 2 mg KOH/g. The resin was cooled down to 150° C. and poured out. After cooling down a white semi-crystalline resin was obtained.

The resin had the following properties:

| | |
|---|---|
| Acid number | 1.5 mg KOH/g |
| Hydroxyl number | 51 mg KOH/g |
| Viscosity (125° C.) | 1.2 Pa · s |
| Melting range | 86-96° C. |

Semi-Crystalline Polyester Resin C2

A 2-liter reaction vessel equipped with a stirrer, a thermometer, a distilling unit, and a nitrogen inlet was charged with 713.2 g (9.8 equivalents) of adipic acid, 786.8 g (10.9 equivalents) of 1,4-dimethylol cyclohexane, and 0.75 g of dibutyl tin oxide. With stirring and passing over nitrogen the temperature was slowly raised to 240° C., with water being discharged. The reaction was continued until the polyester had an acid number lower than 2 mg KOH/g. The resin was cooled down to 150° C. and poured out. After cooling down a white semi-crystalline resin was obtained.

The resin had the following properties:

| | |
|---|---|
| Acid number | 0.8 mg KOH/g |
| Hydroxyl number | 50 mg KOH/g |
| Viscosity (125° C.) | 1.1 Pa · s |
| Melting range | 83-104° C. |

Semi-Crystalline Polyester Resin C3

A 2-liter reaction vessel equipped with a stirrer, a thermometer, a distilling unit, and a nitrogen inlet was charged with 710.7 g (9.7 equivalents) of adipic acid, 741.8 g (10.3 equivalents) of 1,4-dimethylol cyclohexane, 47.5 g of trimethylol propane (1.1 equivalents), and 0.75 g of dibutyl tin oxide. With stirring and passing over nitrogen the temperature was slowly raised to 240° C., with water being discharged. The reaction was continued until the polyester had an acid number lower than 2 mg KOH/g. The resin was cooled down to 150° C. and poured out. After cooling down a white semi-crystalline resin was obtained.

The resin had the following properties:

| | |
|---|---|
| Acid number | 1.5 mg KOH/g |
| Hydroxyl number | 51 mg KOH/g |
| Viscosity (125° C.) | 0.7 Pa · s |
| Melting range | 68-85° C. |

Semi-Crystalline Polyester Resin C4

A 2-liter reaction vessel equipped with a stirrer, a thermometer, a distilling unit, and a nitrogen inlet was charged with 719.9 g (9.8 equivalents) of adipic acid, 703.2 g (9.8 equivalents) of 1,4-dimethylol cyclohexane, 76.9 g of trimethylol propane (1.7 equivalents), and 0.75 g of dibutyl tin oxide. With stirring and passing over nitrogen the temperature was slowly raised to 240° C., with water being discharged. The reaction was continued until the polyester had an acid number lower than 2 mg KOH/g. The resin was cooled down to 150° C. and poured out. After cooling down a white semi-crystalline resin was obtained.

| | |
|---|---|
| Acid number | 1.4 mg KOH/g |
| Hydroxyl number | 51 mg KOH/g |
| Viscosity (125° C.) | 1.3 Pa · s |
| Melting range | 64-81° C. |

Semi-Crystalline Polyester Resin C5

A 2-liter reaction vessel equipped with a stirrer, a thermometer, a distilling unit, and a nitrogen inlet was charged with 599.4 g (10.1 equivalents) of 1.6-hexanediol. With stirring and passing over nitrogen the temperature was slowly raised to 80° C., until a clear solution was obtained. In addition 629.1 g (7.6 equivalents) of terephthalic acid, 271.5 g of adipic acid (3.7 equivalents), and 0.75 g of dibutyl tin oxide were added. With stirring and passing over nitrogen the temperature was slowly raised to 240° C., with water being discharged. The reaction was continued until the polyester had an acid number around 50 mg KOH/g. The resin was cooled down to 150° C. and poured out. After cooling down a white semi-crystalline resin was obtained.

The resin had the following properties:

| | | |
|---|---|---|
| Acid number | 49.2 | mg KOH/g |
| Hydroxyl number | 1 | mg KOH/g |
| Viscosity (125° C.) | 2.0 | Pa · s |

| | |
|---|---|
| Melting range | 100-115° C. |

### General Procedure for the Preparation and Application of Hot Melt Coatings

The hot melt coatings as described in the following examples are prepared by first dry mixing all the raw materials in a high-speed dry mixer type Mixaco® CM 3-12D at 1000 rpm for 20 minutes. The so obtained dry mixture is compounded in a Buss Kneader® extruder, type PLK 46, with barrel temperature at 115° C. and screw speed of 100 rpm. The extrudate is cooled down by passing through chilling rolls and collected as such. For the application of the hot melt coatings the extruded coating composition is heated up to application temperature and applied as hot melt at temperatures in general below 150° C. on a metal strip in a layer thickness between 30 and 55 μm. The applied coating is cured in an air circulation oven for a maximum 90 seconds at a peak metal temperature (PMT) of 225° C.

### Comparative Examples A and B—Hot Melt Coating Compositions Based on 100% Amorphous Polyester Resins

TABLE 1

| | Comparative | Comparative |
|---|---|---|
| Raw Materials | Example A | Example B |
| resin A1 | 515 | |
| resin A2 | | 557 |
| Vestagon ® BF1540 | | 98 |
| Crelan ® VPLS 2147 | 142 | |
| Benzoin | 3 | 3 |
| Resiflow ® PV88 | 10 | 10 |
| Kronos ® 2310 | 330 | 332 |

The melt viscosity, reverse impact strength, T-bend, and pencil hardness were tested. The glass transition temperature Tg was determined before and after curing. The test results are given in the last table, Table 9.

The results described in Table 9 make it clear that the hot melt coating compositions based on 100% amorphous polyesters as described in WO 95/21706 already have a high melt viscosity at 150° C. At lower application temperatures this melt viscosity will be much higher still (at 120° C.>1000 Pa.s). This results in poor film appearance after application of the hot melt coating. The results also show that the applied coatings have low impact resistance and poor T-bend flexibility.

### EXAMPLES 1-5

### Varying Weight Ratio Amorphous/Semi-Crystalline Resin

In Examples 1-5, hot melt coating compositions were prepared comprising a combination of an amorphous resin and a semi-crystalline resin. The weight ratio of amorphous resin content to semi-crystalline content was varied gradually from 90/10 in Example 1 to 50/50 in Example 4. In Example 5, the same weight ratio was used as in Example 2, but with a different amorphous resin. The contents of these compositions are shown in Table 2.

TABLE 2

| | Ex- | Ex- | Ex- | Ex- | Ex- |
|---|---|---|---|---|---|
| | ample | ample | ample | ample | ample |
| Raw Materials | 1 | 2 | 3 | 4 | 5 |
| Wt. ratio amorphous to | 90/10 | 70/30 | 60/40 | 50/50 | 70/30 |
| semi-crystalline | | | | | |
| Amorphous resin A1 | 495 | 385 | 330 | 275 | |
| Amorphous resin A3 | | | | | 365 |
| Semi-cryst. Resin C1 | 55 | 165 | 220 | 275 | |
| Semi-cryst. Resin C2 | | | | | 156 |
| Vestagon ® BF1540 | 137 | 137 | 137 | 137 | |
| Crelan ® VPLS 2147 | | | | | 156 |
| DBTDL | | | | | 10 |
| Benzoin | 3 | 3 | 3 | 3 | 3 |
| Resiflow ® PV88 | 10 | 10 | 10 | 10 | 10 |
| Kronos ® 2310 | 300 | 300 | 300 | 300 | 300 |

The results in Table 9 show that hot melt coating compositions based on combinations of amorphous and semi-crystalline polyester resins have much better mechanical properties than compositions without semi-crystalline polyester. The higher the level of semi-crystalline polyester resin, the better the impact resistance and T-bend flexibility will be. Also the melt viscosity decreases substantially, which results in coating films with excellent flow and without any film defects. Further, higher levels of semi-crystalline resins give lower crosslink density, as shown by the results of the solvent (MEK) resistance tests. Example 5 shows that also a hot melt formulation based on a super-durable amorphous polyester resin can be formulated with excellent paint properties.

### EXAMPLES 6 and 7

In Examples 6 and 7, both hot melt coating compositions had a weight ratio of amorphous to semi-crystalline resin of 90:10. In Example 6, resin A1 was combined with branched semi-crystalline resin C3. In Example 7, resin A1 was combined with branched semi-crystalline resin C4.

TABLE 3

| Raw Materials | Example 6 | Example 7 |
|---|---|---|
| Resin A1 | 455.1 | 456.5 |
| Resin C3 | 50.6 | |
| Resin C4 | | 50.7 |
| Crelan ® VPLS 2147 | 145.3 | 145.3 |
| DBTDL | 6 | 6 |
| Benzoin | 3 | 3 |
| Resiflow ® PV88 | 8 | 8 |
| Kronos ® 2310 | 330 | 330 |

As shown by the results for Examples 6 and 7 in Table 9, if hot melt coating compositions based on a blend of amorphous polyester and branched semi-crystalline polyester resin are used, very good mechanical properties are obtained in combination with a high Tg of the film after cure. Also a better pencil hardness is obtained using branched semi-crystalline polyesters.

EXAMPLES 8-12

### Hot Melt Coating Compositions with Crosslink Enhancers

In Examples 8-12, hot melt coating compositions were prepared comprising a blend of amorphous resin, a semi-crystalline resin, and a crosslink enhancer. In all examples, the coating composition comprises di-trimethylol propane as crosslink enhancer. In Example 9, next to di-trimethylol propane Araldite® PT810 was used as a second crosslink enhancer.

TABLE 4

| Raw Materials | Ex. 8 | Ex. 9 | Ex. 10 | Ex. 11 | Ex. 12 |
|---|---|---|---|---|---|
| Wt ratio amorphous | 90/10 | 90/10 | 80/20 | 70/30 | 60/40 |
| to semi-crystalline | | | | | |
| Di-TMP | 6 | 10 | 10 | 10 | 10 |
| Araldite ® PT810 | | 6 | | | |
| Resin A1 | 417.3 | 442.4 | 370.9 | 324.6 | 278.2 |
| Resin C1 | 46.4 | 49 | 92.7 | 139.1 | 185.5 |
| Crelan ® VPLS 2147 | 177.3 | 138.6 | 177.3 | 177.3 | 177.3 |
| DBTDL | 6 | 8 | 6 | 6 | 6 |
| Crylcoat ® 164 | | 3 | | | |
| Benzoin | 3 | 3 | 3 | 3 | 3 |
| Resiflow ® PV88 | 10 | 10 | 10 | 10 | 10 |
| Kronos ® 2310 | 330 | 330 | 330 | 330 | 330 |

The results in Table 9 show that the addition of crosslink enhancer to the hot melt coating formulations results in clearly improved film properties. Mechanical properties, in particular impact resistance and T-bend as well as pencil hardness, improve substantially. Also the cured film Tg increases if small amounts of crosslink enhancer are used. By adjusting the amorphous/semi-crystalline polyester ratio in combination with a certain amount of crosslink enhancer the desired balance of final paint properties can be set.

### EXAMPLES 13-17

In Examples 13-17, hot melt coating compositions having different crosslink enhancers were prepared. In all examples, the weight ratio of amorphous resins to semi-crystalline resins is 80:20.

TABLE 5

| Raw | | | | | |
|---|---|---|---|---|---|
| Materials | Ex. 13 | Ex. 14 | Ex. 15 | Ex. 16 | Ex. 17 |
| Crosslink | Primid ® | Di-TMP/ | Di-TMP/ | Di-TMP/ | Di-TMP/ |
| Enhancer | XL-552 | Primid ® | Araldite | Aral- | Aral- |
| type | | XL-552 | DY0396 ® | dite ® | dite ® |
| | | | | PT910 | PT810 |
| Amount | 20 | 20/10 | 20/10 | 20/10 | 20/10 |
| Resin A1 | 556 | 538 | 538 | 538 | 538 |
| Resin C1 | 139 | 134 | 134 | 134 | 134 |
| Crelan ® | 274 | 287 | 287 | 287 | 287 |
| VPLS | | | | | |
| 2147 | | | | | |
| Benzoin | 3 | 3 | 3 | 3 | 3 |
| Resi- | 8 | 8 | 8 | 8 | 8 |
| flow ® | | | | | |
| PV88 ® | | | | | |

The results in Table 9 show that various hot melt compositions based on a combination of amorphous and semi-crystalline polyesters can be formulated with different types and amounts of crosslink enhancer, all with improved paint properties.

### EXAMPLES 18-21

In Examples 18-21, formulations were based on high levels of branched semi-crystalline polyester resins in combination with a crosslink enhancer.

TABLE 6

| Raw Materials | Ex. 18 | Ex. 19 | Ex. 20 | Ex. 21 |
|---|---|---|---|---|
| Wt. ratio amorphous | 90/10 | 80/20 | 70/30 | 60/40 |
| to semicrystalline | | | | |
| Di-TMP | 10 | 10 | 10 | 10 |
| Resin A1 | 413.7 | 364.6 | 316.3 | 268.9 |
| Resin C4 | 46 | 91.2 | 135.6 | 179.3 |
| Crelan ® VPLS 2147 | 181.3 | 185.2 | 189.1 | 192.9 |
| DBTDL | 6 | 6 | 6 | 6 |
| Benzoin | 3 | 3 | 3 | 3 |
| Resiflow ® PV88 | 10 | 10 | 10 | 10 |
| Kronos ® 2310 | 330 | 330 | 330 | 330 |

In Table 9, the test results show that the hot melt formulations of Examples 18-21 have an excellent balance of properties.

### EXAMPLES 22-26

In Examples 22-26, hot melt coating compositions all having different hardeners were formulated, as shown in the following Table 7.

TABLE 7

| Raw Materials | Ex. 22 | Ex. 23 | Ex. 24 | Ex. 25 | Ex. 26 |
|---|---|---|---|---|---|
| Weight ratio amorphous | 80/20 | 85/15 | 85/15 | 85/15 | 63/37 |
| to semi-crystalline | | | | | |
| Resin A1 | 441.1 | | 541.3 | 556.9 | 318.6 |
| Uralac ® P6401 | | 546.6 | | | |
| Resin C1 | 110.3 | | | | 79.6 |
| Resin C5 | | 96.5 | 95.5 | 98.3 | |
| Vestagon ® B1530 | 137.6 | | | | |
| Araldite ® PT810 | | 45.9 | | | |
| Araldite ® PT910 | | | 52.2 | | |
| Crelan ® VPLS 2147 | | | | | 106.4 |
| DDA | | | | | 106.4 |
| Primid ® XL-552 | | | | 33.8 | 74 |
| DBTDL | | | | | 4 |
| Benzoin | 3 | 3 | 3 | 3 | 3 |
| Resiflow ® PV88 | 8 | 8 | 10 | 10 | 8 |
| Kronos ® 2310 | 300 | 300 | 300 | 300 | 300 |

In Table 9, the test results show that different hot melt formulations (Examples 22-26) can be formulated which all have good paint properties.

### EXAMPLES 27 and 28

In Example 27 the same formulation was used as in Example 28. The formulation, as shown in Table 8, has a high pigment concentration.

In Example 27, the pigment was first dispersed in the semi-crystalline resin by means of a dissolver. To this end, the semi-crystalline polyester resin was charged to the dissolver, followed by heating to just above the melting temperature. In addition the pigment was gradually added and dispersed. In a next step, which was performed in an extruder, the amorphous resin was blended with the prepared pigment concentrate, resulting in a highly pigmented hot melt coating composition. When applied on a metal strip, very good hiding power was achieved already at a layer thickness of 30 μm while the desired mechanical properties were maintained.

In Example 28, the pigment was dispersed in the mixture of amorphous and semi-crystalline polyester resin. In this case good hiding power was achieved at 45-55 μm, but increased pigment concentration resulted in a substantial decrease of the mechanical properties.

TABLE 8

| Raw Materials | Example 27 | Example 28 |
|---|---|---|
| Resin A1 | 301.5 | 301.5 |
| Semi-crystalline Ex. C2 | 129.2 | 129.2 |
| Crelan ® VP LS 2147 | 106.3 | 106.3 |
| Benzoin | 3 | 3 |
| Resiflow ® PV88 | 10 | 10 |
| Kronos ® 2310 | 450 | 450 |

TABLE 9

| | Melt viscosity | | | | | | |
|---|---|---|---|---|---|---|---|
| | (10 Hz, | Reverse | | | MEK | Tg uncured | Tg |
| | 150° C.) | Impact | | Pencil | (double | composition | cured |
| Example | (Pa.s) | (kg/m) | T-Bend | Hardness | rubs) | (° C.) | film (° C.) |
| A | 195 | 20 | >2T | H-2H | >100 | 54 | 65 |
| B | 93 | 40 | >2T | H-2H | >100 | 52 | 67 |
| 1 | 48 | 80 | 2T | F-HB | >100 | 48 | 65 |
| 2 | 25 | 160 | 1T | B-F | >100 | 39 | 41 |
| 3 | 16 | 160 | 0T | 2B-B | 70 | 26 | 36 |
| 4 | 13 | 160 | 0T | <2B | 50 | 23 | 24 |
| 5 | — | 160 | 0T | HB-H | >100 | 30 | 39 |
| 6 | 61 | 160 | 0.5-0T | HB-H | >100 | 38 | 58 |
| 7 | 60 | 160 | 0.5-0T | HB-H | >100 | 38 | 60 |
| 8 | 51 | 160 | 0.5-1T | HB-H | >100 | 36 | 60 |
| 9 | 47 | 160 | 0.5-1T | HB-H | >100 | 34 | 64 |
| 10 | 26 | 160 | 0T | HB-H | >100 | 26 | 52 |
| 11 | 18 | 160 | 0T | B-HB | >100 | 22 | 43 |
| 12 | 8 | 160 | 0T | 2B-B | >100 | 10 | 32 |
| 13 | 30 | 160 | 0T | HB-H | >100 | 31 | 48 |
| 14 | 25 | 160 | 0T | HB-H | >100 | 25 | 50 |
| 15 | 25 | 160 | 0T | HB-H | >100 | 26 | 51 |
| 16 | 39 | 160 | 0T | HB-H | >100 | 29 | 48 |
| 17 | 25 | 160 | 0T | HB-H | >100 | 29 | 52 |
| 18 | 57 | 160 | 0T | HB-H | >100 | 36 | 64 |
| 19 | 36 | 160 | 0T | B-HB | >100 | 30 | 57 |
| 20 | 28 | 160 | 0T | B-HB | >100 | 24 | 50 |
| 21 | 20 | 160 | 0T | B-HB | >100 | 18 | 42 |
| 22 | — | 160 | 0T | HB-H | >100 | — | 58 |
| 23 | — | 160 | 0T | HB-H | >100 | — | — |
| 24 | — | 160 | 0.5-0T | B-HB | >100 | — | — |
| 25 | — | 160 | 0.5-0T | HB-H | >100 | — | — |
| 26 | — | 160 | 0T | H-2H | >100 | — | — |
| 27 | 23 | 160 | 0T | — | >100 | — | — |
| 28 | — | 100 | >1T | | >100 | | |

1. Thermosetting hot melt coating composition with a binder comprising:
a. 40-95% by total resin weight of at least one amorphous resin; and
b. 5-60% by total resin weight of at least one semi-crystalline and/or crystalline resin.

2. Coating composition according to claim 1 wherein the binder is 50 to 90% by weight amorphous resin.

3. Coating composition according to claim 1 wherein the binder is 10 to 50% by weight said semi-crystalline and/or crystalline resin.

4. Coating composition according to claim 1 wherein the composition further comprises one at least one polyisocyanate as crosslinker, and wherein the amorphous resin and said semi-crystalline and/or crystalline resin have isocyanate-reactive functional groups.

5. Coating composition according to claim 4 wherein the polyisocyanate is a blocked polyisocyanate.

6. Coating composition according to claim 4 wherein the crosslinker is an internally blocked polyisocyanate.

7. Coating composition according to claim 6 wherein said internally blocked polyisocyanate is isocyanurate and/or uretdione.

8. Coating composition according to claim 1 having at least one semi-crystalline resin that is a polyester.

9. Coating composition according to claim 1 having at least one crystalline resin being urethane polyols and/or amide polyols.

10. Coating composition according to claim 1 wherein the composition comprises at least one non-polymeric crosslink enhancer having at least two functional groups capable of reacting with the functional groups of the crosslinker, one or more of the resins, or both.

11. Coating composition according to claim 1 wherein said non-polymeric crosslink enhancer has more than two functional groups

12. Coating composition according to claim 10 wherein the crosslink enhancer comprises at least one polyol having a molecular weight average weight lower than 1,000.

13. Coating composition according claim 1 wherein the melt viscosity of the composition is below 70 Pa.s measured at a temperature of 150° C.

14. Coating composition according to claim 1 wherein the Tg of the cured coatings film is at least 25° C.

15. Method of coating a substrate comprising the following steps:
a. blending the contents of a coating composition comprising a binder comprising 40-95% by total resin weight of at least one amorphous resin and 5-60% by total resin weight of at least one crystalline resin and/or semi-crystalline resin;
b. melting the composition by means of a compounder to the application temperature;
c. applying the coating composition on the substrate;
d. heating the applied coating composition to the curing temperature.

16. Method according to claim 15 wherein before the amorphous resin is blended with said other resins, pigments are dispersed in at least one of said other resin.

17. Method according to claim 15 wherein said compounder is an extruder.

18. Method according to claim 15 wherein the binder is 10 to 50% by total weight said other resin.

19. Method according to claim 15 wherein the binder is 10 to 90% by total resin weight amorphous resin.
